(19) United States
(12) Patent Application Publication
(10) Pub. No.: US 2014/0324358 A1
(43) Pub. Date: Oct. 30, 2014

(54) SURFACE MULTIPLE PREDICTION

(71) Applicant: WESTERNGECO L.L.C., HOUSTON, TX (US)

(72) Inventor: PHILIP WILLIAM KITCHENSIDE, ORPINGTON (GB)

(73) Assignee: WESTERNGECO L.L.C., HOUSTON, TX (US)

(21) Appl. No.: 14/178,049

(22) Filed: Feb. 11, 2014

Related U.S. Application Data
(60) Provisional application No. 61/815,536, filed on Apr. 24, 2013.

(51) Int. Cl. G01V 1/30

(52) U.S. Cl. CPC G01V 1/30
USPC 702/17; 702/14

(57) ABSTRACT

Methods and computing systems for processing collected data are disclosed. In one embodiment, a method is provided for predicting a plurality of surface multiples for a plurality of target traces in a record of multi-component seismic data acquired in a survey area. The method may select a target trace. The method may select an aperture of potential downward reflection points for the target trace. The method may calculate dip propagation attributes from the multi-component seismic data. The method may map the dip propagation attributes into a multiple contribution attribute gather based on the aperture. The method may modify the aperture based on the multiple contribution attribute gather. The method may then predict multiples for the selected target trace using the modified aperture.

### CROSS-REFERENCE TO RELATED APPLICATION

This application claims the benefit of U.S. Provisional Patent Application Ser. No. 61/815,536 filed Apr. 24, 2013, which is incorporated herein by reference in its entirety.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and applicant neither concedes nor acquiesces to the position that any given reference is prior art or analogous prior art.

Seismic exploration may utilize a seismic energy source to generate acoustic signals that propagate into the earth and partially reflect off subsurface seismic reflectors (e.g., interfaces between subsurface layers). The reflected signals are recorded by sensors (e.g., receivers or geophones located in seismic units) laid out in a seismic spread covering a region of the earth's surface. The recorded signals may then be processed to yield a seismic survey.

In general, sensors may detect reflected signals that include primaries and multiples as well as other noise sources in the environment. A primary may be a seismic wave that has reflected once off an interface before being detected by a sensor. A multiple, on the other hand, may be a seismic wave that has reflected off an interface more than once, i.e., multiple times. Other types of noise may include direct arrivals, ground-roll, ambient noise, or any other noise.

As those with skill in the art will appreciate, processing techniques for seismic data may be successfully applied to other types of collected data in varying circumstances as will be discussed herein.

Accordingly, there is a desire for methods and computing systems that can employ more effective and accurate methods for identifying, isolating and/or processing various aspects of seismic signals or other data that is collected from a subsurface region or other multi-dimensional space.

### SUMMARY

In one embodiment, a method is provided for predicting a plurality of surface multiples for target traces in a record of multi-component seismic data acquired in a survey area. The method may select a target trace. The method may select an aperture of potential downward reflection points for the target trace. The method may calculate dip propagation attributes from the multi-component seismic data. The method may map the dip propagation attributes into a multiple contribution attribute gather based on the aperture. The method may modify the aperture based on the multiple contribution attribute gather. The method may then predict multiples for the selected target trace using the modified aperture.

In one embodiment, a method is provided for predicting a plurality of surface multiples for target traces in a record of multi-component seismic data acquired in a survey area. The method may select a target trace. The method may select an aperture of potential downward reflection points for the target trace. The method may calculate dip propagation attributes from the multi-component seismic data. The method may map the dip propagation attributes into a multiple contribution attribute gather based on the aperture. The method may reduce noise artifacts in a multiple prediction for the selected target trace. The noise artifacts may be reduced using the multiple contribution attribute gather.

In one embodiment, a method is provided that includes selecting a target signal. The method may select an aperture of potential downward reflection points for the target signal. The method may calculate dip propagation attributes from a multi-component dataset. The method may map the dip propagation attributes into a multiple contribution attribute gather based on the aperture. The method may reduce noise artifacts in a noise prediction for the selected target signal. The noise artifacts may be reduced using the multiple contribution attribute gather.

The above referenced summary section is provided to introduce a selection of concepts that are further described below in the detailed description section. The summary is not intended to identify features of the claimed subject matter, nor is it intended to be used to limit the scope of the claimed subject matter. Furthermore, the claimed subject matter is not limited to implementations that address any disadvantages noted in any part of this disclosure. Indeed, the systems, methods, processing procedures, techniques and workflows disclosed herein may complement or replace conventional methods for identifying, isolating, and/or processing various aspects of seismic signals or other data that is collected from a subsurface region or other multi-dimensional space, including time-lapse seismic data collected in a plurality of surveys.

### BRIEF DESCRIPTION OF THE DRAWINGS

Implementations of various technologies will hereafter be described with reference to the accompanying drawings. It should be understood, however, that the accompanying drawings illustrate various implementations described herein and are not meant to limit the scope of various technologies described herein.

FIG. 1 illustrates a diagrammatic view of marine seismic surveying in accordance with various implementations described herein.

FIG. 2 illustrates a flow diagram of the first stage in a method for predicting multiples in accordance with various implementations described herein.

FIG. 3 illustrates a flow diagram of the second stage in a method for predicting multiples in accordance with various implementations described herein.

FIG. 4 illustrates a multiple prediction aperture in accordance with various implementations described herein.

FIG. 5 illustrates a gather in accordance with various implementations described herein.

FIG. 6 illustrates a gather in accordance with various implementations described herein.

FIG. 7 illustrates a flow diagram of the first stage in a method for performing a three dimensional surface multiple prediction in accordance with various implementations described herein.

FIGS. 8A and 8B illustrate a flow diagram of the second stage in a method for performing a three dimensional surface multiple prediction in accordance with various implementations described herein.

FIG. 9 illustrates a plan view of an acquisition geometry in accordance with various implementations described herein.

FIG. 10 illustrates a computer system in which the various technologies and techniques described herein may be incorporated and practiced.

### DETAILED DESCRIPTION

The discussion below is directed to certain specific implementations. It is to be understood that the discussion below is for the purpose of enabling a person with ordinary skill in the art to make and use any subject matter defined now or later by the patent claims.

Reference will now be made in detail to various implementations, examples of which are illustrated in the accompanying drawings and figures. In the following detailed description, numerous specific details are set forth in order to provide a thorough understanding of the claimed invention. However, it will be apparent to one of ordinary skill in the art that the claimed invention may be practiced without these specific details. In other instances, well known methods, procedures, components, circuits, and networks have not been described in detail so as not to unnecessarily obscure aspects of the claimed invention.

It will also be understood that, although the terms first, second, etc., may be used herein to describe various elements, these elements should not be limited by these terms. These terms are used to distinguish one element from another. For example, a first object or block could be termed a second object or block, and, similarly, a second object or block could be termed a first object or block, without departing from the scope of various implementations described herein. The first object or block, and the second object or block, are, both, objects or blocks, respectively, but they are not to be considered the same object or block.

The terminology used in the description herein is for the purpose of describing particular implementations and is not intended to limit the claimed invention. As used herein, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises,” and/or “comprising,” when used in this specification, specify the presence of stated features, integers, blocks, operations, elements, and/or components, but do not preclude the presence or addition of one or more other features, integers, blocks, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Various implementations described herein are directed to a method used to predict multiples on a target trace. This method may include several blocks.

In the first block, dip propagation attributes (or dip fields) may be calculated from multi-component (or multi-measurement) seismic data. While the plural is used for purposes of illustration, those with skill in the art will appreciate that one or more dis propagation attributes may be calculated. These dip propagation attributes may include directional information that describes the propagation of a wavefield incident to a seismic receiver or detector. For instance, dip propagation attributes may include the incidence or dip angle defined with respect to the upward vertical direction (i.e., the z-axis) or an azimuthal angle defined with respect to an arbitrary direction within the horizontal x-y plane. Dip propagation attributes may also include related dip information such as event times, source and receiver positions and pressure amplitude data as well as other dip propagation attributes.

In the second block, events from pressure data may be identified and dip propagation attributes corresponding to those events may be selected. For instance, pressure traces may be examined for peaks and troughs that may also be well-defined. Dip propagation attributes calculated in the first block may be matched up with the identified events to form dip traces that may provide a sparse representation of the dip propagation attributes.

In the third block, the dip traces may be mapped into an attribute gather (which hereinafter may be referred to as a multiple contribution attribute gather (MCAG)) using a dip operator. This dip operator may include a convolution-like process between two traces, Trace A and Trace B, to produce attribute gather traces. Trace A may correspond to seismic energy that has traveled from a source location to a downward reflection point (DRP). Trace B may correspond to energy that has traveled from the same downward reflection point as Trace A to a receiver location. Trace B may correspond to a seismic trace recorded at the receiver location. For the output of the convolution-like process, an amplitude value may be defined as the product between the amplitudes of Trace A and Trace B data. The resultant time for the multiple contribution attribute gather may be defined as the sum of the events times on Trace A and Trace B. The outputs of one or more functions that use dip propagation attributes may also be included in the multiple contribution attribute gather. For instance, the multiple contribution attribute gather may display the difference between the incident and the reflected angle at the DRP location used by Trace A and Trace B.

In the fourth block, the multiple contribution attribute gather may be used to determine an aperture for predicting multiples on a target trace as well as for removing artifacts from the predicted multiples. An initial aperture may be selected for determining potential downward reflection points for the target trace. By examining apices in the multiple contribution attribute gather, the aperture may be increased or decreased based on the proximity of particular apices to the aperture's boundaries. In a multiple contribution attribute gather that illustrates the differences between the incident angles (Trace A) and the reflected angles (Trace B) at a DRP location, an apex may be a region where the difference is approximately zero or equal to zero (i.e., a region where Snell's law is satisfied or approximately satisfied).

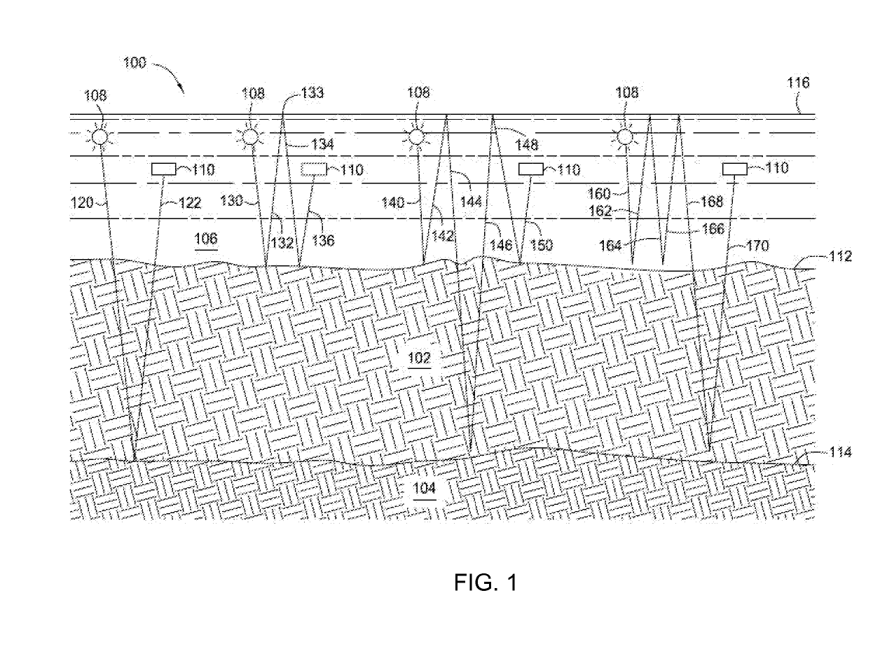

Various implementations described above will now be described in more detail with reference to FIGS. 1-10.

FIG. 1 illustrates a diagrammatic view of marine seismic surveying 100 in accordance with implementations of various techniques described herein. Although various techniques described herein are with reference to a marine seismic survey, it should be understood that these various techniques may also be applied to a land seismic survey.

Subterranean formations to be explored, such as 102 and 104, lie below a body of water 106. Seismic energy sources 108 and seismic receivers 110 may be positioned in the body of water 106, by one or more seismic vessels (not shown). A seismic source 108, such as an air gun, creates seismic waves in the body of water 106 and a portion of the seismic waves travels downward through the water toward the subterranean formations 102 and 104 beneath the body of water 106. When the seismic waves reach a seismic reflector, a portion of the seismic waves reflects upward and a portion of the seismic waves continues downward. The seismic reflector can be the water bottom 112 or one of the interfaces between two subterranean formations, such as interface 114 between formations 102 and 104. When the reflected waves traveling upward reach the water/air interface at the water surface 116, a portion of the waves reflects downward again. Continuing in this fashion, seismic waves can reflect multiple times between upward reflectors, such as the water bottom 112 or formation interfaces below, and the downward reflector at the water surface 116 above, as described more fully below. At a time when the reflected waves propagate past the position of seismic receiver 110, the seismic receiver 110 senses the reflected waves and generates representative signals.

Primary reflections are those seismic waves which have reflected once, from the water bottom 112 or an interface between subterranean formations, before being detected by a seismic receiver 110. An example of a primary reflection is shown in FIG. 1 by raypaths 120 and 122. Primary reflections include the desired information about the subterranean formations which is the goal of marine seismic surveying. Surface multiples are those waves which have reflected multiple times between the water surface 116 and any upward reflectors, such as the water bottom 112 or formation interfaces, before being sensed by a receiver 110. An example of a surface multiple which is specifically a water bottom multiple is shown by raypaths 130, 132, 134 and 136. The point on the water surface 116 at which the wave is reflected downward is generally referred to as the downward reflection point 133. The surface multiple starting at raypath 130 is a multiple of order one, since the multiple contains one reflection from the water surface 116. Two examples of general surface multiples with upward reflections from both the water bottom 112 and formation interfaces are shown by raypaths 140, 142, 144, 146, 148 and 150 and by raypaths 160, 162, 164, 166, 168 and 170. Both of these latter two examples of surface multiples are multiples of order two, since the multiples contain two reflections from the water surface 116. In general, a surface multiple is of order i if the multiple contains i reflections from the water surface 116. Surface multiples are generally considered extraneous noise which may obscure the desired primary reflection signal.

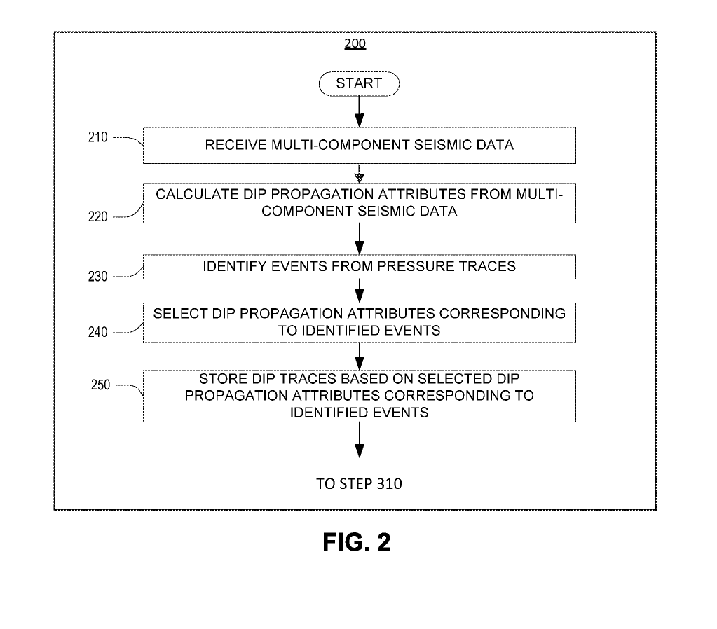

FIG. 2 illustrates a flow diagram of the first stage in a method 200 for predicting multiples in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted. Additionally, those with skill in the art will recognize that in some implementations, blocks may be combined and/or altered to account for introduction or exclusion of certain functionality from other aspects of this disclosure and/or other advantageous techniques in the art.

At block 210, multi-component or multi-measurement seismic data is received. Multi-component seismic data may be acquired from multi-component sensors or receivers on a streamer. The multi-component seismic data may include the vertical and cross-line accelerations of a passing wavefield in addition to scalar pressure values.

At block 220, dip propagation attributes may be calculated from the multi-component seismic data received in block 210. Dip propagation attributes may include the incidence angle (the angle as measured from the vertical direction) of the wavefield received by a seismic receiver, an azimuthal angle (the angle between the projection of the propagation direction onto the x-y plane and a given direction in the x-y plane) of the wavefield received by the seismic receiver, the angle of incidence from the source-side, the azimuthal angle from the source side, and various other attributes. Information on calculating incidence and azimuthal angles using multi-component receivers may be found in U.S. patent application Publication Ser. No. 11/771,947, entitled ESTIMATING AND USING SLOWNESS VECTOR ATTRIBUTES IN CONNECTION WITH A MULTI-COMPONENT SEISMIC GATHER, filed Jun. 29, 2007, published as US 2009/0003132 A1, which is herein incorporated by reference in its entirety. The source-side dip propagation attributes may be calculated by applying finite-difference spatial derivative operators or cross-correlation methods to low-frequency common-receiver pressure gathers. In particular, such methods may be used wherever the assumption of horizontally layered subsurface geology is invalid. If the assumption is valid, the source-side attributes may be equal to those on the receiver side apart from a possible change of sign depending on the sign convention used. Other dip propagation attributes may include related survey data, such as the recorded time of measurements or positioning data of the sources or receivers using to acquire the multi-component data.

At block 230, events may be identified using pressure traces from the multi-component data received in block 210. Identifying events rather than using data for the majority of the calculated dip propagation attributes may reduce computation costs for later blocks. Examples of identified events may include well-defined peaks or troughs. A well-defined peak may be defined by the following inequality:

peak: p(t−2dt)<p(t−dt)<p(t)>p(t+dt)>p(t+2dt) Equation 1

Where p is data from a pressure trace, t ranges from start time to end time for the pressure trace, and dt represents the time sample interval of the pressure trace. Equation 1 describes monotonic decreasing values of pressure around the peak, p(t). A well-defined trough may be defined by the following inequality using the same variables:

trough: p(t−2dt)>p(t−dt)>p(t)<p(t+dt)<p(t+2dt) Equation 2

Equation 2 describes monotonic increasing values of pressure around the trough, p(t).

In one implementation, events may also be based on well-defined peaks or troughs of pressure having amplitudes above a predetermined threshold. A time window may be specified and the amplitudes of the well-defined peaks or troughs within the time window may be compared. If the amplitude of one of the peaks or troughs is above the predetermined threshold, then that event may be selected. This may be performed using a moving time windowed section of a pressure trace. The root mean square (RMS) amplitude of peaks and troughs within a time window may also be used as the predetermined threshold, where the predetermined threshold may be a specified percentage of the RMS amplitude with a current time window.

At block 240, dip propagation attributes that correspond to the identified events to form dip traces are selected. A dip trace may provide a sparse representation of the dip propagation attributes calculated in block 220. Data in a dip trace may include the following parameters for a sample, (ampᵢ, tᵢ, φ_{Ri}, φ_{Si}, θ_{Ri}, θ_{Si}, sₓ, s_{y}, rₓ, r_{y}), where i=1, . . . , N with N being the number of samples or events, ampᵢ represents the pressure amplitude for the event, tᵢ represents the time of the event, φ_{Ri} the azimuthal angle of the event from the receiver side, φ_{Si} represents the azimuthal angle of the event from the source side, θ_{Ri} represents the incidence angle of the event from the receiver side, θ_{Si} represents the incidence angle of the event from the source side, sₓ represents the source location for the event according to the x-axis, s_{y} represents for the source location for the event according to the y-axis, rₓ represents the receiver location for the event according to the x-axis, and r_{y} represents the receiver location according to the y-axis.

At block 250, the dip traces from block 240 are stored for later processing.

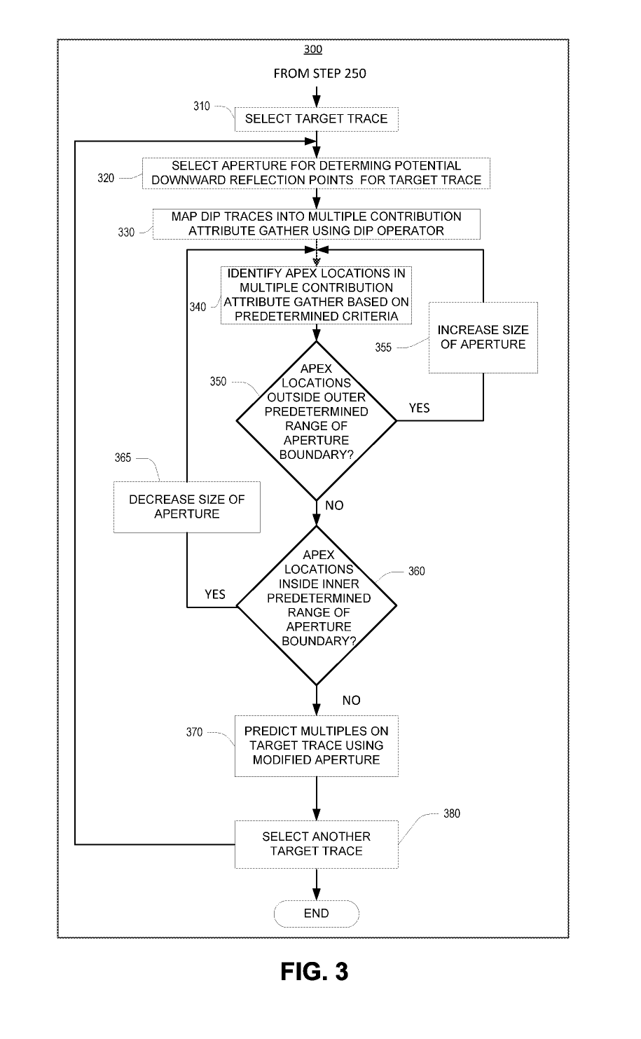

FIG. 3 illustrates a flow diagram of the second stage in a method 300 for predicting multiples in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted. Additionally, those with skill in the art will recognize that in some implementations, blocks may be combined and/or altered to account for introduction or exclusion of certain functionality from other aspects of this disclosure and/or other advantageous techniques in the art. The following description of method 300 is made with reference to method 200 of FIGS. 2 and 4-6.

At block 310, a target trace is selected. A target trace is a seismic trace that may be acquired in a seismic survey for which multiple energy is to be predicted on the particular seismic trace.

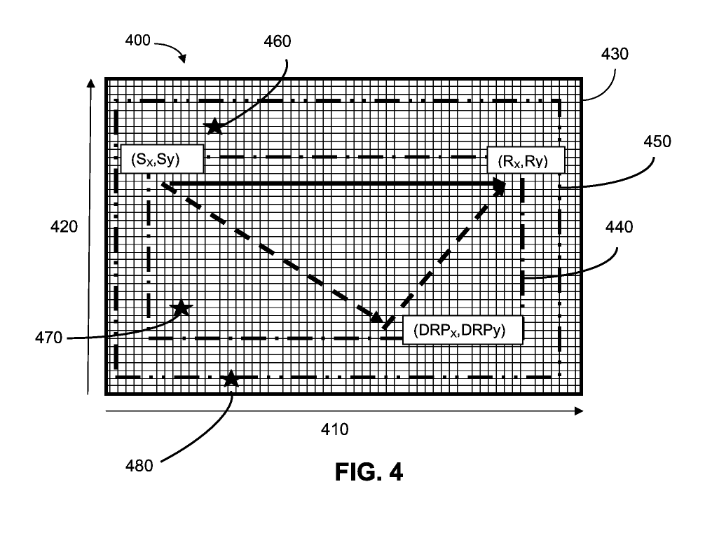

At block 320, an initial aperture for determining potential downward reflection points for the target trace is selected. An aperture may correspond to a surface area divided into a grid of cells. The initial aperture may be set to a predetermined width and length to create aperture boundaries for capturing downward reflection points within those aperture boundaries. An example of a selected aperture 400 may be found in FIG. 4. The selected aperture 400 may be a rectangular area as shown. However, other geometrical shapes for the selected aperture 400 are contemplated by the various implementations described herein. In FIG. 4, the aperture's width corresponds to the x-axis 410, and the aperture's length corresponds to the y-axis 420. An aperture boundary 430 shows the edge of the selected aperture 400. One downward reflection point is labeled in FIG. 4 at coordinates, (DRPₓ, DRP_{y}), with the selected target trace being at (Rₓ,R_{y}), for a source located at (Sₓ,S_{y}).

Blocks 330 to 365 may describe an aperture optimization process to produce an aperture sufficient for covering the downward reflection points used for predicting multiples on the target trace. Blocks 330 to 365 may iterate until the apex locations in the multiple contribution attribute gather are between an inner predetermined range and an outer predetermined range of the aperture boundary 430.

At block 330, the dip traces from block 240 may be mapped into a multiple contribution attribute gather by using a dip operator on the dip traces. This dip operator may include a convolution-like process between two traces, Trace A and Trace B. The convolution-like process is further described or expressed with reference to Equation 5. Trace A may correspond to a dip trace from a source location (Sₓ, S_{y}) to a receiver location (DRPₓ, DRP_{y}) for a downward reflection point (DRP). Trace A for N_{A} samples may be defined by the following equation:

TraceA={ampᵢ^{A},tᵢ^{A},θ_{Ri}^{A},θ_{Si}^{A},φ_{Ri}^{A},φ_{Si}^{A}}_{i=1, . . . N}_{_{A}} Equation 3

Since a receiver may not be located at the downward reflection point, Trace A may be computed or estimated using a variety of different methods. Examples of such methods are described in block 220 for calculating source-side dip propagation attributes.

Trace B may correspond to a trace from a source location (DRPₓ, DRP_{y}) at the location of the same downward reflection point as Trace A to a receiver location (Rₓ, R_{y}). Trace B may be based on a recorded seismic trace. Trace B for N_{B} samples may be defined by the following equation:

TraceB={ampⱼ^{B},tⱼ^{B},θ_{Rj}^{B},θ_{Sj}^{B},φ_{Rj}^{B},φ_{Sj}^{B})}_{j=1, . . . N}_{_{B}} Equation 4

Applying a dip operator to produce individual attribute gather traces for the multiple contribution attribute gather may be represented by the following equation:

AttributeGatherTrace={ampᵢ^{A}×ampⱼ^{B},tᵢ^{A},ƒ(θ_{Ri}^{A},θ_{Sj}^{B},φ_{Ri}^{A},φ_{Sj}^{B})}_{i=1, . . . N}_{_{A}}_{; j=1, . . . N}_{_{B}} Equation 5

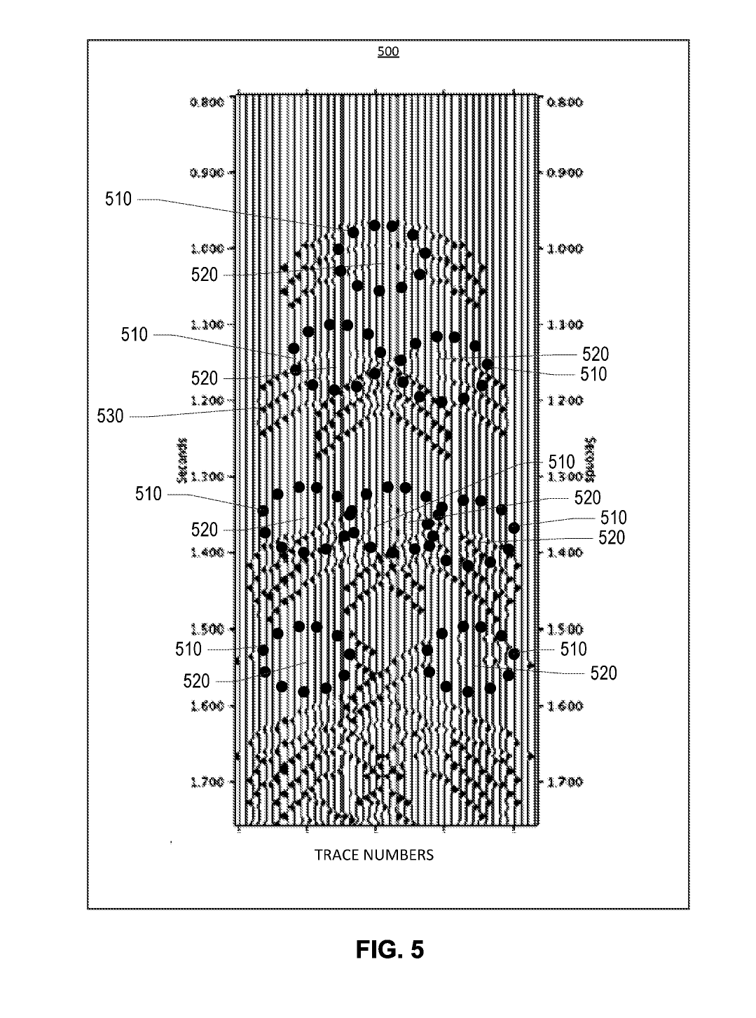

An attribute gather trace in the multiple contribution attribute gather may have several attributes. First, an amplitude value for an attribute gather trace may be defined as the product between the amplitudes of Trace A and Trace B or amp_{GatherTrace}=ampᵢ^{A}×ampⱼ^{B}. The resultant time for an attribute gather trace may be defined as the sum of the events times between Trace A and Trace B or t=tᵢ^{A}+tⱼ^{B}. One or more functions f that use dip propagation attributes as inputs may be another attribute of the attribute gather traces. For instance, the multiple contribution attribute gather may display the results of a function f that measures the difference between the incident and the reflected angles at the DRP location used by Trace A and Trace B. In a multiple contribution attribute gather that is plotted in color, the results of the one or more functions may be displayed according to color-coded assignments. An example, multiple contribution attribute gather 500 may be found in FIG. 5.

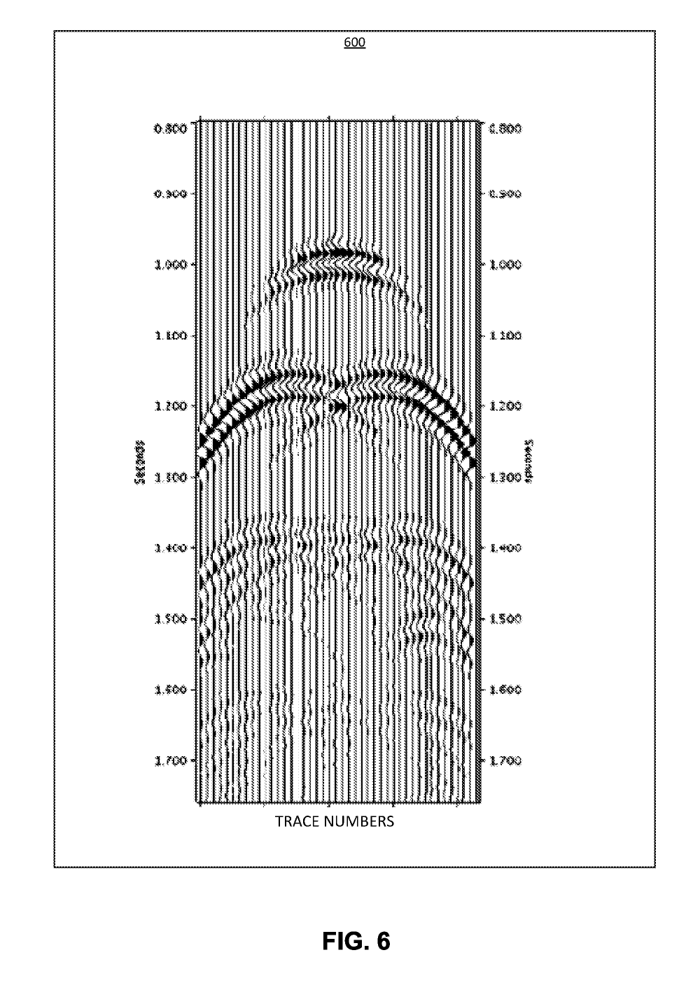

At block 340, one or more apex locations in the multiple contribution attribute gather may be identified based on predetermined criteria. The predetermined criteria may be where the difference between the incident and the reflected angles is approximately zero, which may correspond to locations where Snell's law is approximately satisfied. Looking at FIG. 5, apices 520 are the regions inside the dotted ellipses 510 where the difference between the incident and the reflected angles at the DRP is approximately zero, i.e., where ƒ(θ_{Ri}^{A},θ_{Sj}^{B})=0 is approximately true. Note that the results shown in FIG. 5 are for a two-dimensional seismic survey. In this instance the azimuthal angle may be the same for an event on a trace and may therefore be omitted from the attribute calculation. Amplitude data 530 may also be seen in the multiple contribution attribute gather. The dotted ellipses 510 may provide a boundary for which energy in the vicinity of the apices 520 is captured. The seconds axis of FIG. 5 may correspond to the resultant time for an attribute gather trace. FIG. 5 may be compared to FIG. 6, which shows the corresponding multiple contribution gather (MCG) 600 for the acquired seismic traces.

At block 350, a determination is made as to whether one or more of the apex locations are located outside an outer predetermined range 450 of the aperture boundary 430. The horizontal axis in FIG. 5 may include trace numbers that identify a corresponding attribute gather trace. Given that an attribute gather trace is a function of a DRP location, apex locations in the multiple contribution attribute gather may correspond to cells in the selected aperture 400. The determination in block 350 may measure the distance between the trace location that includes the edge of the outermost ellipses in the multiple contribution attribute gather and the location of the traces for the aperture boundary 430 (i.e., the first trace and the last trace). For instance, if the outer predetermined range 450 is set to be the same as the aperture boundary 430, an ellipse that extends beyond the range of the included traces would be determined to have an apex location outside the outer predetermined range 450. The outer predetermined range 450 may be a predetermined value to ensure that relevant energy is included in the multiple contribution attribute gather, and that the selected aperture 400 does not include irrelevant aperture area. If the apex locations are inside the outer predetermined range 450, the process may proceed to block 360. If the apex locations are outside the outer predetermined range 450, the process may proceed to block 355.

At block 355, the selected aperture 400 is increased. For instance, the selected aperture 400 may be increased according to a block method or a predetermined incremental value for a predetermined aperture dimension. If the current multiple contribution attribute gather does not include data that accounts for the increased aperture, the multiple contribution attribute gather may be recalculated for the additional aperture area. Apex location 480 is an example apex location that may cause the selected aperture 400 to be increased according to block 350. Apex location 460 is an example apex location that may not cause any change in the selected aperture 400 according to block 350. The process may then return to block 340.

At block 360, a determination is made as to whether the apex locations are located inside an inner predetermined range 440 of the aperture boundary 430. The determination in block 360 may be made in a similar fashion to the determination in block 350. The inner predetermined range 440 may be a predetermined value to ensure that relevant energy is included in the multiple contribution attribute gather, and that the selected aperture 400 does not include irrelevant aperture area. If one or more of the apex locations are outside the inner predetermined range 440, the process may proceed to block 370. If the apex locations are inside the inner predetermined range 440, the process may proceed to block 365.

At block 365, the selected aperture 400 is decreased. For instance, the selected aperture 400 may be decreased according to a block method or a predetermined decremental value for a predetermined aperture dimension. Apex location 470 is an example apex location that may cause the selected aperture 400 to be decreased according to block 360 if apex location 470 is the farthest apex location from the selected aperture's center or midpoint. Apex location 460 is an example apex location that may not cause any change in the selected aperture 400 according to block 360. The process may then return to block 340.

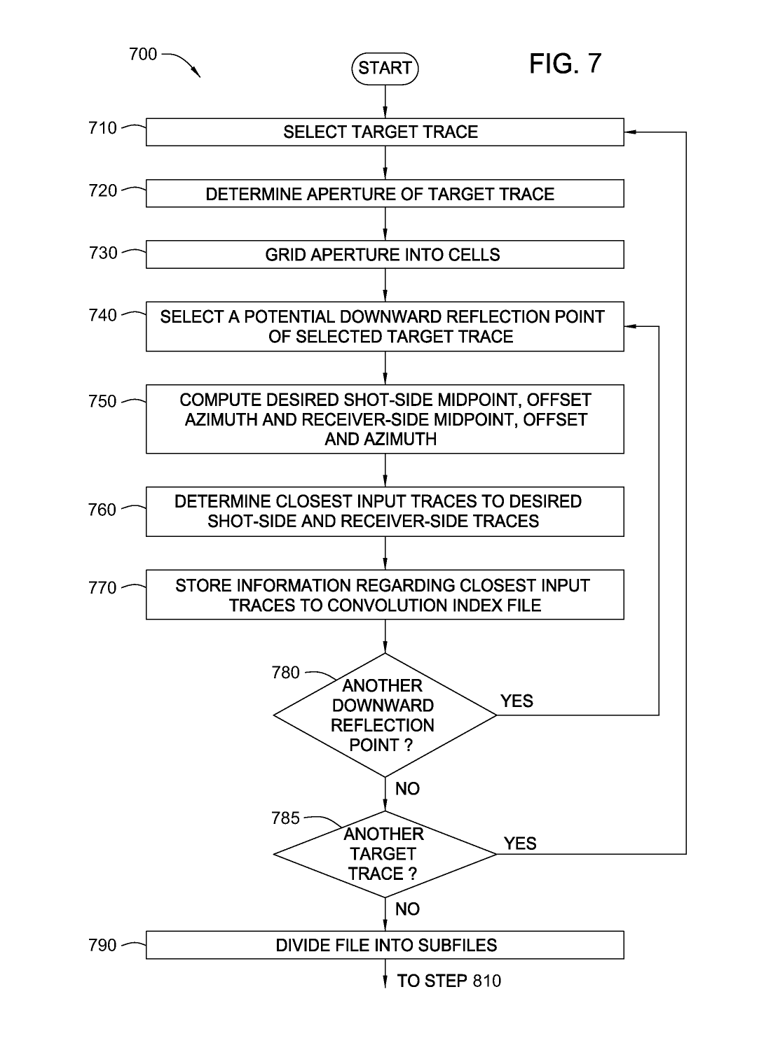

At block 370, multiples in the target trace are predicted using a modified aperture. The modified aperture may be the selected aperture 400 that has been modified at block 355 or block 365 over any number of iterations. Any method of multiple prediction may be used with the modified aperture. The multiple prediction method may construct a multiple contribution gather as shown in FIG. 6 as part of the prediction process. For instance, one multiple prediction method may be found in commonly assigned U.S. patent application Ser. No. 10/599,414, entitled GENERALIZED 3D SURFACE MULTIPLE PREDICTION, filed May 25, 2007, issued as U.S. Pat. No. 7,796,467 B2, which is the U.S. National Stage of the PCT Application PCT/US2004/023119, filed Jul. 16, 2004, both of which are entirely incorporated by reference. A more detailed description of this multiple prediction method is provided in the paragraphs below with reference to FIGS. 7-9.

In one implementation, after identifying the apices 520 in block 340, a taper function in the x-y-t domain may be applied to data used in a multiple contribution gather. The taper function may be a function of x, y and t that leaves energy within a prescribed distance from an apex location untouched, where the apex locations are the apices 520 determined in block 340. At larger distances from the apices 520 and within a boundary region that encloses a pass region, the energy may be tapered down to about 0.0 using a smoothly varying scale factor taking values between about 1.0 to about 0.0. Energy located outside of the boundary and pass regions may be zeroed. This may exclude unwanted contributions or noise artifacts to the multiple predictions or other types of noise predictions.

At block 380, another target trace may be selected for multiple predictions. The process may then return to block 320.

In another implementation, methods 200 and 300 may be used in applications without seismic data. For instance, method 300 may select a target signal in place of a target trace at block 310. The multi-component data from block 210 may not be seismic data, and the dip propagation attributes may be calculated from multi-component data based on measurements from sensors besides seismic receivers. The multiple prediction methods described in FIGS. 2 and 3 may instead be used to predict other types of noise in a target signal, and may be used for a wide range of image processing techniques. In one implementation, the noise artifact reduction of block 370 may be applied to noise artifacts in data regarding various non-seismic data sources. Examples of these non-seismic data sources may include data for human tissue, plant tissue, animal tissue, volumes of water, volumes of air and volumes of space near and/or outside the atmosphere of a planet, asteroid, comet, moon or other body.

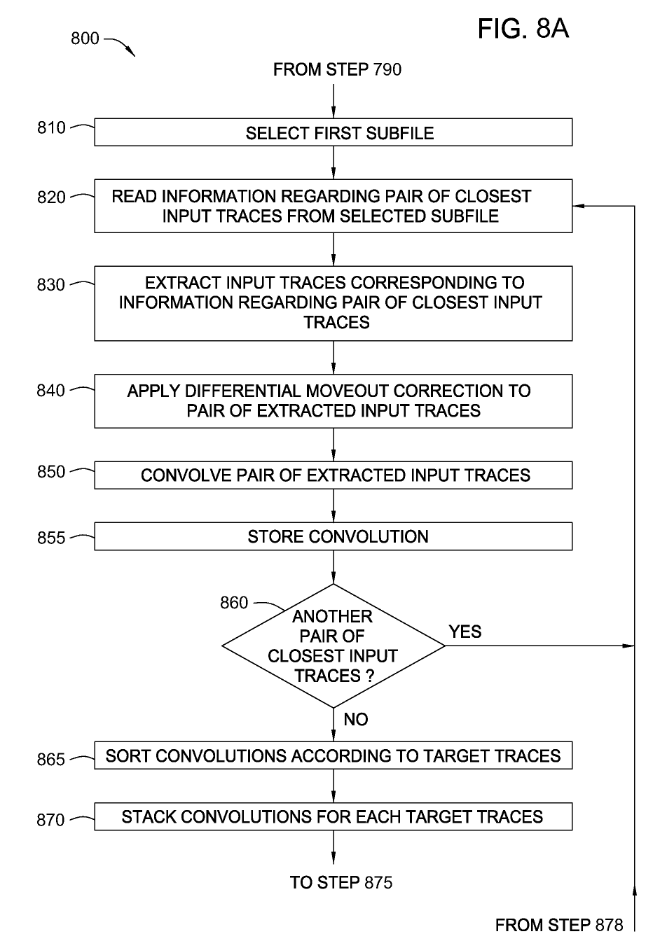

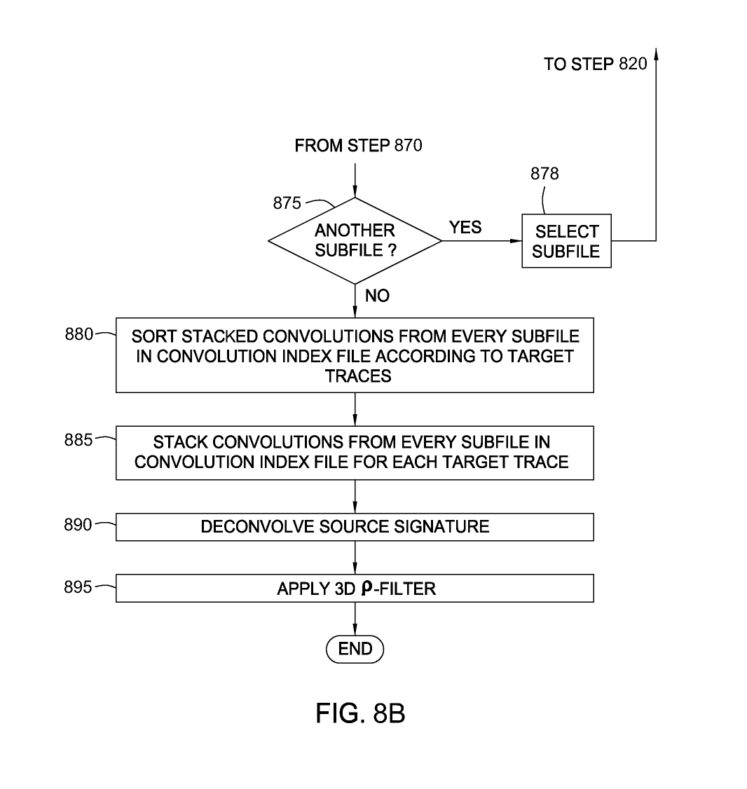

FIGS. 7 and 8A-8B describe various implementations for predicting and removing multiples in target traces in accordance with block 370.

FIG. 7 illustrates a flow diagram of the first stage 700 in a method for performing a three dimensional surface multiple prediction in accordance with implementations of various techniques described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted. Additionally, those with skill in the art will recognize that in some implementations, blocks may be combined and/or altered to account for introduction or exclusion of certain functionality from other aspects of this disclosure and/or other advantageous techniques in the art.

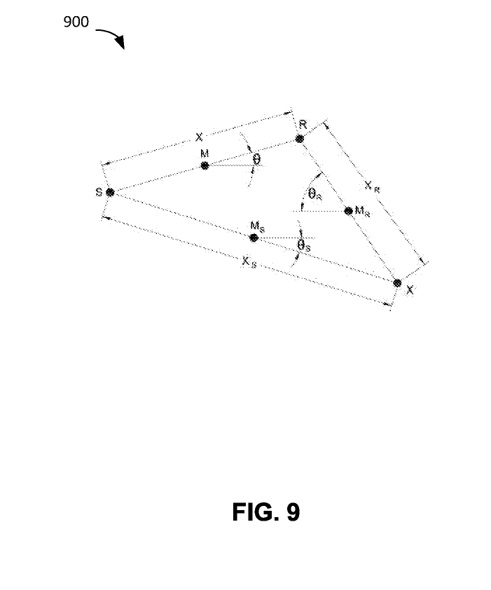

At block 710, a target trace is selected. An example of a selected target trace is illustrated in FIG. 4 as trace (S, R). Target traces define the locations at which the multiples are to be predicted. At block 720, an aperture 900 for the selected target trace is determined or defined. The aperture 900 may be a rectangular area and centered on a midpoint location M of the target trace. Other geometrical shapes for the aperture 900 may be contemplated. The aperture 900 is defined to include a substantial portion of potential downward reflection points (DRPs) of the surface multiples for the target trace. As an example, a potential downward reflection point X is illustrated in FIG. 9. At block 730, the aperture 900 is gridded into a plurality of cells. In one implementation, the midpoint of the target trace is located on one of the grid nodes (cell centers). The grid spacing may be arbitrary. The grid nodes define the potential DRPs for the target trace.

At block 740, a potential DRP, such as a first DRP, for the selected target trace is selected. At block 750, the desired shot-side midpoint M_{S}, offset X_{S} and azimuth θ_{S} and the desired receiver-side midpoint M_{R}, offset X_{R} and azimuth θ_{R} are computed. Ms is the midpoint location between the source and the selected potential DRP. Note that in regard to FIGS. 7 and 8A-8B, the two angles θ_{S} and θ_{R} are now azimuthal angles specifying the direction from the source location to the receiver location (as measured on the acquisition surface). The previous values of θ_{S} and θ_{R} in regard to FIGS. 2-6 denote angles of propagation and do not apply to the first stage 700 or the second stage 800 in the method for three dimensional surface multiple prediction. Offset X_{S} is the horizontal distance between the selected potential DRP and the source S. Azimuth θ_{S} is defined as the angle between the line that connects the source S and the selected potential DRP and some fixed direction, which may be the in-line direction. M_{R} is the midpoint location between the receiver R and the selected potential DRP. Offset X_{R} is the horizontal distance between the selected potential DRP and the receiver R. Azimuth θ_{R} is defined as the angle between the line that connects the receiver R and the selected potential DRP and some fixed direction, which may be the in-line direction. In one implementation, the desired shot-side midpoint M_{S}, offset X_{S} and azimuth θ_{S} and the desired receiver-side midpoint M_{R}, offset X_{R} and azimuth θ_{R} are computed based on the selected target trace and the selected potential DRP. The midpoints, offsets and azimuths together define the desired shot-side trace (S, X) and the desired receiver-side trace (X, R).

At block 760, the input trace closest to the desired shot-side trace and the input trace closest to the desired receiver-side trace are determined. In one implementation, the closest input traces are determined by minimizing an objective function, which defines the closeness of two traces based on their midpoints, offsets and azimuths. An example of an objective function is

D²=|Δm²+wₓ|Δx|²+w_{θ}|Δθ|²

where D measures the closeness between the traces, Δm, Δx and Δθ are the differences in midpoint, offset and azimuth respectively, and wₓ and w_{θ} are weights defining the relative importance of errors in offsets and azimuths as compared to the error in midpoints. Notably, wₓ is dimensionless, whereas w_{θ} has dimensions of L². In one implementation, w_{θ} is set to zero due to poor azimuth coverage of the input dataset. In another implementation, there may be a minimum value for the minimized objective function, above which there is deemed to be no matching trace.

At block 770, information regarding the closest input traces is stored in a file, which may be referred to as a convolution index file (CIF). For example, such information may include identifiers for the closest input traces, their associated subsurface lines, the selected potential downward reflection point X, the desired shot-side midpoint M_{S}, offset X_{S} and azimuth θ_{S}, the desired receiver-side midpoint M_{R}, offset X_{R} and azimuth θ_{R}, and the selected target trace to be predicted. At block 780, a determination is made as to whether the aperture includes another potential DRP for the selected target trace. If the answer is in the affirmative, then processing returns to block 740, at which another potential DRP is selected. If the answer is in the negative, then processing continues to block 785, at which a determination is made as to whether another target trace exists. If the answer is in the affirmative, then processing returns to block 710, at which another target trace is selected. If the answer is in the negative, then processing continues to block 790, at which the CIF is divided into one or more subfiles according to pairs of subsurface lines containing closest input traces. In this manner, a subfile may contain information directed to a pair of subsurface lines, wherein a subsurface line contains an input trace closest to either a desired shot-side trace or a desired receiver-side trace. The order of subsurface lines in the pair is not relevant.

FIGS. 8A and 8B illustrate a flow diagram of the second stage 800 in a method for performing a three dimensional surface multiple prediction in accordance with implementations of various techniques described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted. Additionally, those with skill in the art will recognize that in some implementations, blocks may be combined and/or altered to account for introduction or exclusion of certain functionality from other aspects of this disclosure and/or other advantageous techniques in the art.

At block 810, the first subfile is selected. At block 820, information regarding a pair of input traces closest to a desired shot-side trace and a desired receiver-side trace for a selected target trace is read from the selected subfile. At block 830, a pair of input traces corresponding to the information regarding the pair of closest input traces is extracted from a set of recorded seismic data.

The recorded set of seismic data may be stored in any file or data storage commonly known by persons of ordinary skill in the art. The set of recorded seismic data may be extrapolated to zero offset. The set of recorded seismic data may be a collection of prestack traces defined by midpoint, offset and azimuth. In one implementation, each trace in the recorded seismic data set may have a subsurface line identifier and a unique trace identifier that can be used to identify the input trace within the recorded seismic data set. The set of recorded seismic data may be organized into subsurface lines, or any other subdivisions, such as sail lines.

At block 840, a differential moveout correction is applied to the pair of extracted recorded traces to fix the offsets of the extracted recorded traces to the desired shot-side offset and the desired receiver-side offset. At block 850, the pair of corrected and extracted recorded traces is convolved. At block 855, the convolution is stored.

At block 860, a determination is made as to whether the selected subfile contains another pair of input traces to be convolved. If the answer is in the affirmative, then processing returns to block 820. If the answer is in the negative, then processing continues to block 865, at which the convolutions are sorted according to target traces. At block 870, the convolutions for a target trace may be stacked together to obtain a single, stacked convolution per target trace for the selected subfile.

At block 875, a determination is made as to whether another subfile of the CIF exists. If the answer is in the affirmative, then that subfile is selected (block 878) and processing returns to block 820. If the answer is in the negative, then processing continues to block 880, at which the stacked convolutions from the subfiles in the CIF are sorted according to target traces. At block 885, the stacked convolutions from the subfiles in the CIF are stacked for a target trace to obtain a single, stacked convolution per target trace from the subfiles.

At block 890, the source signature is deconvolved according to techniques commonly known by persons of ordinary skill in the art. At block 895, a three dimensional p-filter may be applied to compensate for the stacking effect on the wavelet according to techniques commonly known by persons of ordinary skill in the art.

In some embodiments, a method is provided for predicting a plurality of surface multiples for a plurality of target traces in a record of multi-component seismic data acquired in a survey area. The method may select a target trace. The method may select an aperture of potential downward reflection points for the target trace. The method may calculate one or more dip propagation attributes from the multi-component seismic data. The method may map the dip propagation attributes into a multiple contribution attribute gather based at least in part on the aperture. The method may modify the aperture based at least in part on the multiple contribution attribute gather. The method may then predict one or more multiples for the selected target trace using the modified aperture.

In another implementation, the dip propagation attributes may describe directional information of seismic wavefields, related dip information or a combination thereof. The method may also identify events from pressure data in the multi-component data. The method may also map the dip propagation attributes that correspond to the identified events. The identified events may include a peak or a trough on a pressure trace. The dip propagation attributes may include the incident angle of a seismic wavefield with respect to the upward vertical direction, an azimuthal angle of a seismic wavefield with respect to a predetermined direction in a horizontal plane, or both. The mapping of dip propagation attributes may be performed using a dip operator. Using a dip operator may include determining traces for the multiple contribution attribute gather based on a difference between predetermined dip propagation attributes for a source-side trace of a downward reflection point and a receiver-side trace of the downward reflection point. The predetermined dip propagation attributes may include the incident angles of the source-side trace and the receiver-side trace. The method may also determine regions in the multiple contribution attribute gather. The regions may include locations on attribute gather traces of the multiple contribution gather where the difference between the predetermined dip propagation attributes at the locations is below a predetermined threshold. The predetermined threshold may correspond to dip propagation attributes for the source-side trace and the receiver-side trace that substantially satisfies Snell's law. Modifying the aperture may include increasing the aperture in response to the regions being located outside a predetermined range of an aperture boundary corresponding to the aperture. Modifying the aperture may include decreasing the aperture in response to the regions being located inside a predetermined range of an aperture boundary corresponding to the aperture. The method may also apply a taper function to reduce energy that is a predetermined distance from the regions in the multiple contribution attribute gather.

In some embodiments, a method is provided for predicting a plurality of surface multiples for a plurality of target traces in a record of multi-component seismic data acquired in a survey area. The method may select a target trace. The method may select an aperture of potential downward reflection points for the target trace. The method may calculate one or more dip propagation attributes from the multi-component seismic data. The method may map the dip propagation attributes into a multiple contribution attribute gather based at least in part on the aperture. The method may reduce noise artifacts in a multiple prediction for the selected target trace. The noise artifacts may be reduced using the multiple contribution attribute gather.

In another implementation, the mapping of dip propagation attributes may be performed using a dip operator. Using a dip operator may include determining traces for the multiple contribution attribute gather based on a difference between predetermined dip propagation attributes for a source-side trace of a downward reflection point and a receiver-side trace of the downward reflection point. The method may also determine regions in the multiple contribution attribute gather. The regions may include locations on attribute gather traces of the multiple contribution gather where the difference between predetermined dip propagation attributes at the locations is below a predetermined threshold. The predetermined threshold may correspond to dip propagation attributes for the source-side trace and the receiver-side trace that substantially satisfies Snell's law. The method may also apply a taper function to reduce energy that is a predetermined distance from the regions in the multiple contribution attribute gather.

In some embodiments, a method for processing collected data corresponding to a multi-dimensional region of interest is provided. The method may select a target signal. The method may select an aperture of potential downward reflection points for the target signal. The method may calculate one or more dip propagation attributes from a multi-component dataset. The method may map the dip propagation attributes into a multiple contribution attribute gather based at least in part on the aperture. The method may reduce noise artifacts in a noise prediction for the selected target signal. The noise artifacts may be reduced using the multiple contribution attribute gather.

In some implementations, the survey area may be a multi-dimensional region of interest. The multi-dimensional region of interest may be a subterranean region, human tissue, plant tissue, animal tissue, volumes of water, volumes of air and volumes of space near and/or outside the atmosphere of a planet, asteroid, comet, moon or other body.

In some implementations, the multi-dimensional region of interest may include one or more volume types such as a subterranean region, human tissue, plant tissue, animal tissue, volumes of water, volumes of air, and volumes of space near and/or or outside the atmosphere of a planet, asteroid, comet, moon, or other body.

In some implementations, an information processing apparatus for use in a computing system is provided, and includes means for selecting a target trace. The information processing apparatus may also have means for selecting an aperture of potential downward reflection points for the target trace. The information processing apparatus may also have means for calculating dip propagation attributes from the multi-component seismic data. The information processing apparatus may also have means for mapping the dip propagation attributes into a multiple contribution attribute gather based on the aperture. The information processing apparatus may also have means for modifying the aperture based on the multiple contribution attribute gather. The information processing apparatus may also have means for predicting multiples for the selected target trace using the modified aperture.

In some implementations, a computing system is provided that includes at least one processor, at least one memory, and one or more programs stored in the at least one memory, wherein the programs include instructions, which when executed by the at least one processor cause the computing system to select a target trace. The programs may further include instructions to cause the computing system to select an aperture of potential downward reflection points for the target trace. The programs may further include instructions to cause the computing system to calculate dip propagation attributes from the multi-component seismic data. The programs may further include instructions to cause the computing system to map the dip propagation attributes into a multiple contribution attribute gather based on the aperture. The programs may further include instructions to cause the computing system to modify the aperture based on the multiple contribution attribute gather. The programs may further include instructions to cause the computing system to then predict multiples for the selected target trace using the modified aperture.

In some implementations, a computer readable storage medium is provided, which has stored therein one or more programs, the one or more programs including instructions, which when executed by a processor, cause the processor to select a target trace. The programs may further include instructions, which cause the processor to select an aperture of potential downward reflection points for the target trace. The programs may further include instructions, which cause the processor to calculate dip propagation attributes from the multi-component seismic data. The programs may further include instructions, which cause the processor to map the dip propagation attributes into a multiple contribution attribute gather based on the aperture. The programs may further include instructions, which cause the processor to modify the aperture based on the multiple contribution attribute gather. The programs may further include instructions, which cause the processor to then predict multiples for the selected target trace using the modified aperture.

In some implementations, an information processing apparatus for use in a computing system is provided, and includes means for selecting a target trace. The information processing apparatus may also have means for selecting an aperture of potential downward reflection points for the target trace. The information processing apparatus may also have means for calculating dip propagation attributes from the multi-component seismic data. The information processing apparatus may also have means for mapping the dip propagation attributes into a multiple contribution attribute gather based on the aperture. The information processing apparatus may also have means for reducing noise artifacts in a multiple prediction for the selected target trace. The noise artifacts may be reduced using the multiple contribution attribute gather.

In some implementations, a computing system is provided that includes at least one processor, at least one memory, and one or more programs stored in the at least one memory, wherein the programs include instructions, which when executed by the at least one processor cause the computing system to select a target trace. The programs may further include instructions to cause the computing system to select an aperture of potential downward reflection points for the target trace. The programs may further include instructions to cause the computing system to calculate dip propagation attributes from the multi-component seismic data. The programs may further include instructions to cause the computing system to map the dip propagation attributes into a multiple contribution attribute gather based on the aperture. The programs may further include instructions to cause the computing system to reduce noise artifacts in a multiple prediction for the selected target trace. The noise artifacts may be reduced using the multiple contribution attribute gather.

In some implementations, a computer readable storage medium is provided, which has stored therein one or more programs, the one or more programs including instructions, which when executed by a processor, cause the processor to select a target trace. The programs may further include instructions, which cause the processor to select an aperture of potential downward reflection points for the target trace. The programs may further include instructions, which cause the processor to calculate dip propagation attributes from the multi-component seismic data. The programs may further include instructions, which cause the processor to map the dip propagation attributes into a multiple contribution attribute gather based on the aperture. The programs may further include instructions, which cause the processor to reduce noise artifacts in a multiple prediction for the selected target trace. The noise artifacts may be reduced using the multiple contribution attribute gather.

In some implementations, an information processing apparatus for use in a computing system is provided, and includes means for selecting a target signal. The information processing apparatus may also have means for selecting an aperture of potential downward reflection points for the target signal. The information processing apparatus may also have means for calculating dip propagation attributes from a multi-component dataset. The information processing apparatus may also have means for mapping the dip propagation attributes into a multiple contribution attribute gather based on the aperture. The information processing apparatus may also have means for reducing noise artifacts in a noise prediction for the selected target signal. The noise artifacts may be reduced using the multiple contribution attribute gather.

In some implementations, a computing system is provided that includes at least one processor, at least one memory, and one or more programs stored in the at least one memory, wherein the programs include instructions, which when executed by the at least one processor cause the computing system to select a target signal. The programs may further include instructions to cause the computing system to select an aperture of potential downward reflection points for the target signal. The programs may further include instructions to cause the computing system to calculate one or more dip propagation attributes from a multi-component dataset. The programs may further include instructions to cause the computing system to map the one or more dip propagation attributes into a multiple contribution attribute gather based on the aperture. The programs may further include instructions to cause the computing system to reduce noise artifacts in a noise prediction for the selected target signal. The noise artifacts may be reduced using the multiple contribution attribute gather.

In some implementations, a computer readable storage medium is provided, which has stored therein one or more programs, the one or more programs including instructions, which when executed by a processor, cause the processor to select a target signal. The programs may further include instructions, which cause the processor to select an aperture of potential downward reflection points for the target signal. The programs may further include instructions, which cause the processor to calculate dip propagation attributes from a multi-component dataset. The programs may further include instructions, which cause the processor to map the dip propagation attributes into a multiple contribution attribute gather based on the aperture. The programs may further include instructions, which cause the processor to reduce noise artifacts in a noise prediction for the selected target signal. The noise artifacts may be reduced using the multiple contribution attribute gather.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

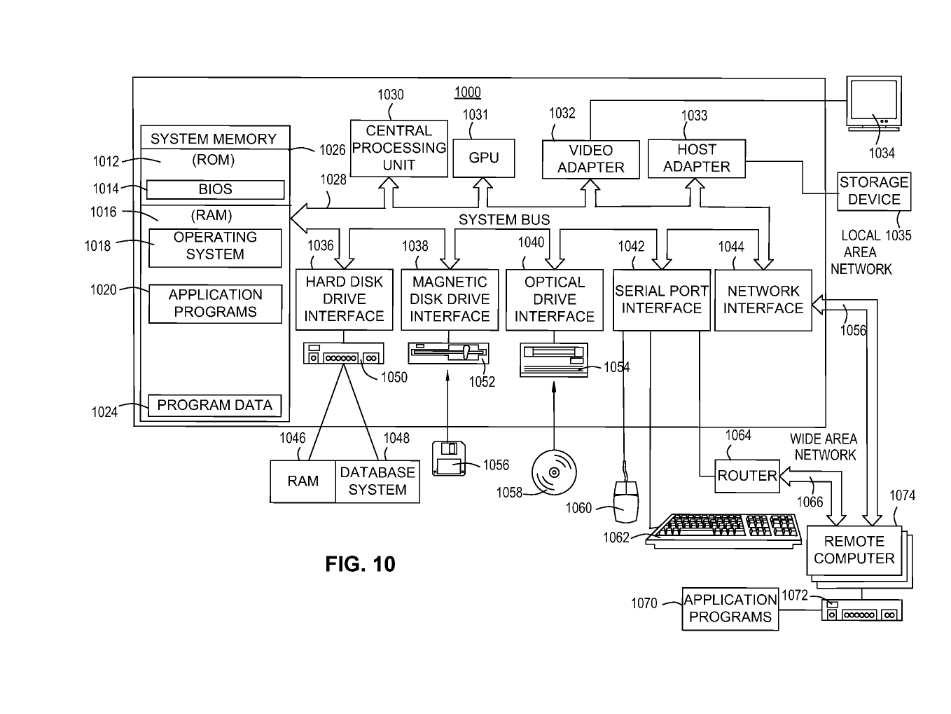

FIG. 10 illustrates a schematic diagram of a computing system 1000 in which the various technologies described herein may be incorporated and practiced. Although the computing system 1000 may be a conventional desktop or a server computer, as described above, other computer system configurations may be used.

The computing system 1000 may include a central processing unit (CPU) 1030, a system memory 1026, a graphics processing unit (GPU) 1031 and a system bus 1028 that couples various system components including the system memory 1026 to the CPU 1030. Although one CPU is illustrated in FIG. 10, it should be understood that in some implementations the computing system 1000 may include more than one CPU. The GPU 1031 may be a microprocessor specifically designed to manipulate and implement computer graphics. The CPU 1030 may offload work to the GPU 1031. The GPU 1031 may have its own graphics memory, and/or may have access to a portion of the system memory 1026. As with the CPU 1030, the GPU 1031 may include one or more processing units, and the processing units may include one or more cores. The system bus 1028 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1026 may include a read-only memory (ROM) 1012 and a random access memory (RAM) 1046. A basic input/output system (BIOS) 1014, containing the basic routines that help transfer information between elements within the computing system 1000, such as during start-up, may be stored in the ROM 1012.

The computing system 1000 may further include a hard disk drive 1050 for reading from and writing to a hard disk, a magnetic disk drive 1052 for reading from and writing to a removable magnetic disk 1056, and an optical disk drive 1054 for reading from and writing to a removable optical disk 1058, such as a CD ROM or other optical media. The hard disk drive 1050, the magnetic disk drive 1052 and the optical disk drive 1054 may be connected to the system bus 1028 by a hard disk drive interface 1056, a magnetic disk drive interface 1058, and an optical drive interface 1050, respectively. The drives and their associated computer-readable media may provide nonvolatile storage of computer-readable instructions, data structures, program modules and other data for the computing system 1000.

Although the computing system 1000 is described herein as having a hard disk, a removable magnetic disk 1056 and a removable optical disk 1058, it should be appreciated by those skilled in the art that the computing system 1000 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1000. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 1000 may also include a host adapter 1033 that connects to a storage device 1035 via a small computer system interface (SCSI) bus, a Fiber Channel bus, an eSATA bus or using any other applicable computer bus interface. Combinations of any of the above may also be included within the scope of computer readable media.

A number of program modules may be stored on the hard disk 1050, magnetic disk 1056, optical disk 1058, ROM 1012 or RAM 1016, including an operating system 1018, one or more application programs 1020, program data 1024 and a database system 1048. The application programs 1020 may include various mobile applications (“apps”) and other applications configured to perform various methods and techniques described herein. The operating system 1018 may be any suitable operating system that may control the operation of a networked personal or server computer, such as Windows® XP, Mac OS® X, Unix-variants (e.g., Linux® and BSD®), and the like.

A user may enter commands and information into the computing system 1000 through input devices such as a keyboard 1062 and pointing device 1060. Other input devices may include a microphone, joystick, game pad, satellite dish, scanner or the like. These and other input devices may be connected to the CPU 1030 through a serial port interface 1042 coupled to system bus 1028, but may be connected by other interfaces, such as a parallel port, game port or a universal serial bus (USB). A monitor 1034 or other type of display device may also be connected to system bus 1028 via an interface, such as a video adapter 1032. In addition to the monitor 1034, the computing system 1000 may further include other peripheral output devices such as speakers and printers.

Further, the computing system 1000 may operate in a networked environment using logical connections to one or more remote computers 1074. The logical connections may be any connection that is commonplace in offices, enterprise-wide computer networks, intranets, and the Internet, such as local area network (LAN) 1056 and a wide area network (WAN) 1066. The remote computers 1074 may be another a computer, a server computer, a router, a network PC, a peer device or other common network node, and may include many of the elements describes above relative to the computing system 1000. The remote computers 1074 may also include application programs 1070 similar to that of the computer action function.

When using a LAN networking environment, the computing system 1000 may be connected to the local network 1056 through a network interface or adapter 1044. When used in a WAN networking environment, the computing system 1000 may include a router 1064, wireless router or other means for establishing communication over a wide area network 1066, such as the Internet. The router 1064, which may be internal or external, may be connected to the system bus 1028 via the serial port interface 1052. In a networked environment, program modules depicted relative to the computing system 1000, or portions thereof, may be stored in a remote memory storage device 1072. It will be appreciated that the network connections shown are merely examples and other means of establishing a communications link between the computers may be used.

The network interface 1044 may also utilize remote access technologies (e.g., Remote Access Service (RAS), Virtual Private Networking (VPN), Secure Socket Layer (SSL), Layer 2 Tunneling (L2T) or any other suitable protocol). These remote access technologies may be implemented in connection with the remote computers 1074.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device and at least one output device. One or more programs that may implement or utilize the various technologies described herein may use an application programming interface (API), reusable controls and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, partly on the user's computing device, as a stand-alone software package, partly on the user's computer and partly on a remote computer or entirely on the remote computer or a server computer.

Those with skill in the art will appreciate that any of the listed architectures, features or standards discussed above with respect to the example computing system 1000 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method for predicting multiples in a plurality of target traces in a record of multi-component seismic data acquired in a survey area, comprising:
selecting a target trace;
selecting an aperture for potential downward reflection points for the target trace;
calculating dip propagation attributes from the multi-component seismic data;
mapping the dip propagation attributes into a multiple contribution attribute gather based on the aperture;
modifying the aperture based on the multiple contribution attribute gather; and
predicting multiples for the selected target trace using the modified aperture.

2. The method of claim 1, wherein the dip propagation attributes describe directional information of one or more seismic wavefields, related dip information, or a combination thereof.

3. The method of claim 1, further comprising identifying events from pressure data in the multi-component data, and wherein mapping the dip propagation attributes comprises mapping the dip propagation attributes that correspond to the identified events.

4. The method of claim 3, wherein the identified events comprise a peak or a trough on a pressure trace.

5. The method of claim 1, wherein the dip propagation attributes comprise the incident angle of a seismic wavefield with respect to the upward vertical direction, an azimuthal angle of a seismic wavefield with respect to a predetermined direction in a horizontal plane, or both.

6. The method of claim 1, wherein mapping the dip propagation attributes is performed using a dip operator.

7. The method of claim 6, wherein using the dip operator comprises determining traces for the multiple contribution attribute gather based on a difference between predetermined dip propagation attributes for a source-side trace of a downward reflection point and a receiver-side trace of the downward reflection point.

8. The method of claim 7, wherein the predetermined dip propagation attributes comprise the incident angles of the source-side trace and the receiver-side trace.

9. The method of claim 7, further comprising determining one or more regions in the multiple contribution attribute gather, wherein the regions comprise locations on attribute gather traces of the multiple contribution attribute gather, wherein the difference between the predetermined dip propagation attributes at the locations is below a predetermined threshold.

10. The method of claim 9, wherein the predetermined threshold corresponds to dip propagation attributes for the source-side trace and the receiver-side trace that substantially satisfies Snell's law.

11. The method of claim 9, wherein modifying the aperture comprises increasing the aperture in response to the regions being located outside a predetermined range of an aperture boundary corresponding to the aperture.

12. The method of claim 9, wherein modifying the aperture comprises decreasing the aperture in response to the regions being located inside a predetermined range of an aperture boundary corresponding to the aperture.

13. The method of claim 9, further comprising applying a taper function to reduce energy that is a predetermined distance from the regions in the multiple contribution attribute gather.

14. A method, comprising:
selecting a target signal;
selecting an aperture of potential downward reflection points for the target signal;
calculating a dip propagation attribute from a multi-component dataset;
mapping the dip propagation attribute into a multiple contribution attribute gather based at least in part on the aperture; and
reducing noise artifacts in a prediction, wherein the noise artifacts are reduced using the multiple contribution attribute gather.

15. A computing system for predicting multiples in a plurality of target traces in a record of multi-component seismic data acquired in a survey area, comprising:
at least one processor,
at least one memory, and
one or more programs stored in the at least one memory, wherein the programs include instructions, which when executed by the at least one processor, cause the computing system to:
select a target trace;
select an aperture of potential downward reflection points for the target trace;
calculate dip propagation attributes from the multi-component seismic data;
map the dip propagation attributes into a multiple contribution attribute gather based on the aperture; and
reduce noise artifacts in a multiple prediction for the selected target trace, wherein the noise artifacts are reduced using the multiple contribution attribute gather.

16. The computing system of claim 15, wherein mapping the dip propagation attributes is performed using a dip operator.

17. The computing system of claim 16, wherein using the dip operator comprises determining traces for the multiple contribution attribute gather based on a difference between predetermined dip propagation attributes for a source-side trace of a downward reflection point and a receiver-side trace of the downward reflection point.

18. The computing system of claim 15, wherein the one or more programs further comprise instructions to determine one or more regions in the multiple contribution attribute gather, wherein the regions comprise locations on attribute gather traces of the multiple contribution attribute gather, wherein a difference between predetermined dip propagation attributes at the locations is below a predetermined threshold.

19. The computing system of claim 18, wherein the predetermined threshold corresponds to dip propagation attributes for the source-side trace and the receiver-side trace that substantially satisfies Snell's law.

20. The computing system of claim 18, wherein reducing noise artifacts using the multiple contribution attribute gather comprises applying a taper function to reduce energy that is a predetermined distance from the regions in the multiple contribution attribute gather.
